(19) United States
(12) Patent Application Publication
(10) Pub. No.: US 2004/0165948 A1
(43) Pub. Date: Aug. 26, 2004

(54) Interconnector for coupling ISO top castings on containers

(75) Inventors: John Hove, Jacksonville, FL (US); Jim Nelson, St. Augustine, FL (US)

Correspondence Address: BROWDY AND NEIMARK, P.L.L.C., 624 NINTH STREET, NW, SUITE 300, WASHINGTON, DC, 20001-5303, US

(73) Assignee: BUFFERS USA INC., Jacksonville, FL (US)

(21) Appl. No.: 10/786,297

(22) Filed: Feb. 26, 2004

Related U.S. Application Data
(60) Provisional application No. 60/449,607, filed on Feb. 26, 2003.

(51) Int. Cl. F16D 1/00

(52) U.S. Cl. 403/408.1

(57) ABSTRACT

An Interconnector device designed to couple the top corner castings together on two ISO containers providing both horizontal pull strength and compression as well as the required 3″ spacer between the outer face of the castings. The device is designed in two pieces rather than just one to overcome the problem of inadequate grip for designs that must be inserted horizontally.

### CROSS-REFERENCE TO RELATED APPLICATION

The present application claims the benefit of U.S. Provisional Appln. No. 60/449,607, filed Feb. 26, 2003.

### BACKGROUND OF THE INVENTION

1. Technical Field of the Invention

The invention is directed to an interconnector device designed to couple together the top corner castings of two ISO containers when they are arranged coaxially along their longitudinal lengths. The interconnector device provides both horizontal pull strength and compression as well as the required three inch (3″) spacer between the opposite outer faces of the coupled corner castings.

### PRIOR ART

There are several known designs of interconnectors to couple together twenty foot (20′) and smaller containers when they are arranged coaxially, but they all must be inserted horizontally and they are all made as a one piece axle with either fixed/welded or loose/threaded heads that lock inside the corner casting. There is no known prior art where an interconnector is made in two parts such as the disclosed design.

### SUMMARY OF THE INVENTION

It is an object of one embodiment of the present invention to provide an interconnector device which is designed to couple together the top corner castings of two ISO containers when coaxially arranged.

It is a further object of one embodiment of the present invention to provide an interconnector device which provides ease of connection.

It is a further object of one embodiment of the present invention to provide an interconnector device which provides both horizontal pull strength and/or compression between the ISO containers.

It is a further object of one embodiment of the present invention to provide an interconnector device which provides a three inch (3″) spacer between the opposite outer faces of the castings as required by current ISO specificiations.

It is a further object of one embodiment of the present invention to provide an interconnector device which has two separate but connectable pieces rather than just one piece.

It is a further object of one embodiment of the present invention to provide an interconnector device which overcomes the problem of inadequate grip of prior art designs that must be inserted horizontally.

It is a further object of one embodiment of the present invention to provide an interconnector device which allows the operator to attach the unit at an angle at each container.

It is a further object of one embodiment of the present invention to provide an interconnector device which is not restricted to a locking/gripping head size that only fits horizontally through the nearly square so-called “A-Corn” end aperture holes on the upper ISO castings.

It is a further object of one embodiment of the present invention to provide an interconnector device which includes two separate but connectable pieces that are fitted in place on two containers, and when the containers are moved together and the two pieces can be locked together by means of a locking pin, if desirable. The locking pin can be eliminated entirely in situations where the interconnector remains in a state of compression between the ISO containers.

The present invention is not to be taken as limited to or by the aforementioned objects.

### BRIEF DESCRIPTION OF THE DRAWINGS

FIG. 1 is a perspective view of a fully assembled interconnector device according to one embodiment of the invention.

FIG. 2 is an elevation view of the device of FIG. 1.

FIG. 3 is a cross-section along section line 3-3 in FIG. 4.

FIG. 4 is a top view of the device of FIG. 2.

FIG. 5 is a side view of the device of FIG. 2.

FIG. 6 is a top view of the device of FIG. 2 shown engaged between the two top corner castings of two ISO containers arranged coaxially.

FIG. 7 is a vertical cross-section through the longitudinal axis of the corner castings and device of FIG. 6 with the device fully shown.

### DETAILED DESCRIPTION OF THE INVENTION

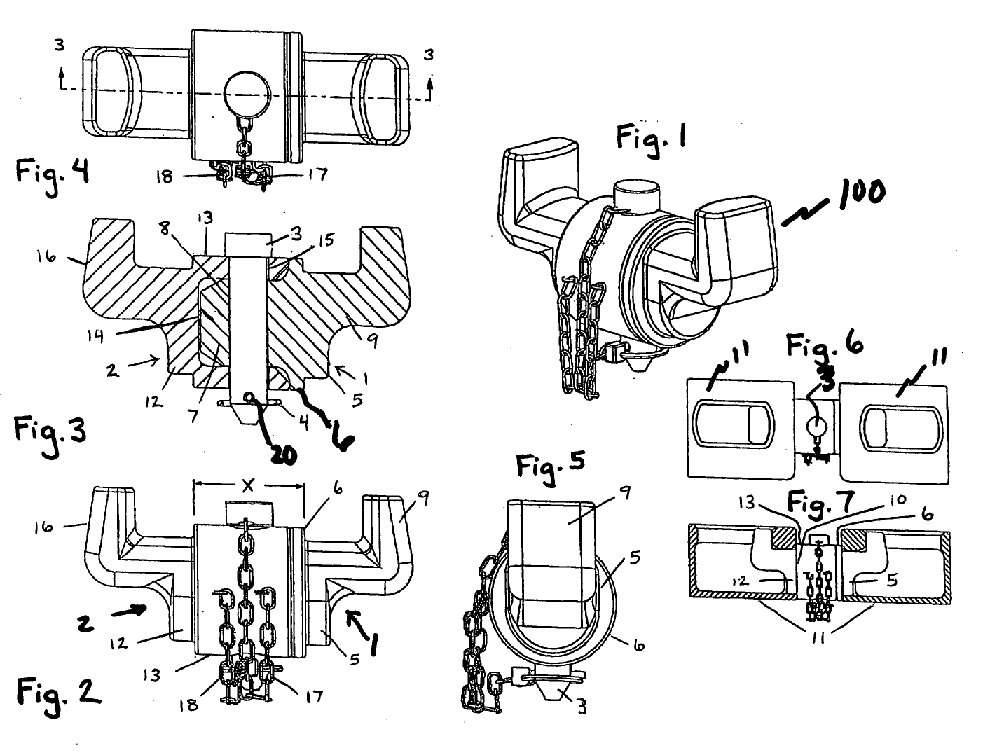

FIG. 1 is a perspective view of a fully assembled interconnector device 100 according to one embodiment of the invention.

As shown in FIGS. 2 and 3, the interconnector device 100 has two connection parts 1 and 2 which are fixed together by a pin 3. Connection part 1 has a body portion 5 which has a cross-section substantially corresponding to the opening of either side through-hole 10 of the corner castings 11 as shown in FIG. 7. A flange 6 which extends out from and around body portion 5 has a cross section which is larger than either side-through-hole 10 of the corner castings 11. Projection 7, which also extends out from body portion 5, is provided with a through-hole 8 to accommodate pin 3. Finally, a hook portion 9 which extends out from body portion 5 is adapted to fit through either side-through-hole 10 at an angle, if necessary, and engage inside wall of the casting 11 above side-through-hole 10.

Connection part 2, which has a body portion 12, is provided with a flange 13 which extends out from and around body portion 12 to form a recess 14. Recess 14 is adapted to receive and engage projection 7 of connection part 1 after which pin 3 is engaged in through-hole 15 of flange 13 and through-hole 8 of projection 7. The cross-section through flange 13 of connection part 2 is equivalent to that of flange 6 of connection part 1 and therefore larger than the opening of the side-through-hole 10 of the corresponding casting 11. Distance ‘x’ between the sides of flanges 13 and 6 is at least three inches (3″) to provide the required spacing between the two connected ISO containers when the interconnector device 100 is in place. The hook 16 extending from body portion 12 of connection part 1 is identical in shape and size to that of hook 9 of connection part 1 and as such engages the corresponding casting 11 in the same manner as hook 9 engages corresponding casting 11.

Finally, to maintain pin 3 in engagement in through-holes 8 and 15, a linch pin 4 is inserted through a hole 20 in the bottom portion of pin 3. A linch pin chain 17 is engaged between pin 3 and flange 13 and a linch pin chain 18 engaged between the linch pin 4 and flange 13.

The interconnector device according to the invention is designed to couple together the top corner castings of two ISO containers when coaxially arranged to provide ease of connection and both horizontal pull strength and/or compression between the ISO containers as well as the required three inch (3″) spacer between the opposite outer faces of the castings. The device is designed in two pieces rather than just one to overcome the problem of inadequate grip of prior art designs that must be inserted horizontally. Making the unit in two pieces also allows the operator to attach the unit at an angle at each container and not be restricted to a locking/gripping head size that only fits horizontally through the nearly square so-called “A-Corn” end aperture holes on the upper ISO castings. Once the two halves are fitted in place, the containers are moved together, the two connection parts can be secured together by means of the locking pin 3. However, as noted above, the locking pin 3, linch pin 4, hole 20, pin chains 17, 18 and corresponding through-holes 8, 15 all can be eliminated when the interconnector is used in a situation where the interconnector remains in a state of compression between ISO containers. The bottom ISO corner castings are locked together with conventional interconnectors, such as Buffers model 1208, when two empty twenty-foot (20′) (that is, 19′ 10½″) containers are locked together in the described way. When locked together they can be lifted as one forty-foot (40′) unit, thereby reducing handling, loading and unloading charges to half the cost.

The foregoing description of the specific embodiments will so fully reveal the general nature of the invention that others can, by applying current knowledge, readily modify and/or adapt for various applications such specific embodiments without departing from the generic concept, and, therefore, such adaptions and modifications should and are intended to be comprehended within the meaning and range of equivalents of the disclosed embodiments. It is to be understood that the phraseology or terminology employed herein is for the purpose of description and not of limitation.

What is claimed is:

1. An interconnector device for coupling together top corner castings of adjacent longitudinally ISO containers comprising:
a first connection part having a first body portion;
a first flange extending out from the first body portion;
a projection extending out from the first body portion and away from the first flange;
a second connection part having a second body portion;
a second flange extending out from the second body portion, the second flange having a recess corresponding to the projection extending out from the first body portion; and
wherein adjacent longitudinally aligned ISO containers are coupled together by respectively engaging the first body portion and the second body portion in a corresponding top corner casting of the top corner castings and engaging the projection of the first body portion in the recess of the second body portion.

2. The interconnector device according to claim 1, wherein the first body portion and the second body portion each have a cross-sectional area corresponding to that of side openings on the top corner castings.

3. The interconnector device according to claim 1, wherein the first body portion and the second body portion each have a hook portion adapted to pass through side openings of the top corner castings and engage at an inside wall of the top corner castings.

4. The interconnector device according to claim 1, wherein the first flange and the second flange each have a cross-sectional area larger than that of side openings in the top corner castings.

5. The interconnector device according to claim 1, wherein the first flange and the second flange respectively extend around the first body portion and the second body portion.

6. The interconnector device according to claim 1, wherein a pin is engaged in an aligned through hole through the projection and the second flange.

7. The interconnector device according to claim 6, wherein a linch pin is provided to extend through the pin to secure engagement of the pin in the aligned through hole.

8. The interconnector according to claim 7, wherein the linch pin and the pin are chained to the second flange.

9. An interconnector adapted to couple together two ISO containers comprising:
a substantially L-shaped first connector;
a substantially L-shaped second connector which fits within a recess formed in the first connector;
wherein the first connector comprises:
a first body portion;
a first flange extending from one end of the first body portion and around the first body portion;
a projection extending out from the first body portion beyond the first flange; and
a first hook portion extending out from the first body portion.
wherein the second connector comprises:
a second body portion;
a second flange extending from and around one end of the second body portion and forming a recess; and
a second hook extending out from the second body portion.

10. The interconnector according to claim 9, wherein
the first and second connectors have through-holes defined therein which are aligned with one another when the second connector is fitted within the recess in the first connector; and
a pin is inserted into the through-holes in the first and second connectors when the second connector is fitted within the recess in the first connector for securing the first and second connectors to one another.

11. The interconnector according to claim 10, further comprising:
a linch pin adapted to be inserted in a hole formed in a bottom portion of the pin; and
at least one chain connected between the pin, the second flange and the linch pin.

12. The interconnector according to claim 9,
wherein the first body portion has a cross-section corresponding to a side opening of a first top corner casting;
the first flange has a cross-section which is larger than the side opening of the first top corner casting; and
the first hook portion is adapted to fit through the engaged side opening of the first top corner casting and engage an inside wall thereof.

13. The interconnector according to claim 12,
wherein the second body portion has a cross-section corresponding to a side opening in a second top corner casting opposite the first top corner casting;
the second flange has a cross-section which is larger than the engaged side opening in the second top corner casting and equal to that of the first flange, the second hook is adapted to fit through the engaged side opening in the second top corner casting and engage an inside wall thereof; and
the interconnector is adapted to couple two containers by respectively inserting the first hook and the second hook through the corresponding side opening in the corresponding top corner casting and inserting the projection into the recess.

14. An interconnector adapted to couple together two ISO containers having at least two top corner castings comprising:
a first connector means for engaging a side opening of a first top corner casting;
a second connector means adapted to fit within a recess formed in the first connector means and engage a side opening of a second top corner casting opposite the first top corner casting.

15. The interconnector according to claim 14, wherein the first connector means comprises:
a first body portion;
a first flange extending from one end of the first body portion and around the first body portion;
a projection extending out from the first body portion beyond the first flange; and
a first hook portion extending out from the first body portion.

16. The interconnector according to claim 15, wherein the second connector means comprises:
a second body portion;
a second flange extending from and around one end of the second body portion and forming a recess, the second flange having a cross-section which is equal to that of the first flange; and
a second hook extending out from the second body portion.

17. The interconnector according to claim 15, wherein the first body portion has a cross-section corresponding to a side opening of a first top corner casting;
the first flange has a cross-section which is larger than the side opening of the first top corner casting; and
the first hook portion is adapted to fit through the engaged side opening of the first top corner casting and engage an inside wall thereof.

18. The interconnector according to claim 17, wherein the second body portion has a cross-section corresponding to the engaged side opening in a second top corner casting opposite the first top corner casting;
the second flange has a cross-section which is larger than the side opening in the second top corner casting and equal to that of the first flange, the second hook is adapted to fit through the engaged side opening in the second top corner casting and engage an inside wall thereof; and
the interconnector is adapted to couple two containers by respectively inserting the first hook and the second hook through the corresponding side opening in the corresponding top corner casting and inserting the projection into the recess so that the pin can be inserted through the through-holes in the first and second connectors after being aligned to fix the interconnector in the first and second top corner casting.

19. The interconnector according to claim 14, wherein a pin can be inserted through through-holes in the first and second connectors after the second connector is engaged within the recess in the first connector.

20. The interconnector according to claim 19, further comprising:
second pin means for securing the position of the first pin means with respect to the first and second connector means; and
at least one chain connected between the second pin means, the second connector means and the second pin means.
